(19) United States
(12) Patent Application Publication
(10) Pub. No.: US 2011/0022459 A1
(43) Pub. Date: Jan. 27, 2011

(54) METHOD FOR TRACKING RESPONSES TO ADVERTISING CAMPAIGNS

(76) Inventors: Michael Milanese, Winnipeg (CA); Michael Szajewski, Winnipeg (CA)

Correspondence Address: ADE & COMPANY INC., 2157 Henderson Highway, WINNIPEG, MB, R2G1P9, CA

(21) Appl. No.: 12/507,910

(22) Filed: Jul. 23, 2009

(51) Int. Cl. G06Q 30/00; G06N 5/02; G06Q 10/00

(52) U.S. Cl. 705/14.45; 706/52

(57) ABSTRACT

A method for tracking responses to advertising campaigns is provided where a client places advertisements in a plurality of different outlet media channels for accessing target recipients of the campaign. The method acts to monitor location responses from recipients and attribute the responses to the different outlet media channels either by providing different response addresses for the different outlet media channels and routing the responses to or through the monitoring location or by evaluating those responses which are not attributed by a neural network to analyze response data and attribute each response to a specific media channel. The data is displayed in real time on a display screen for the client showing real time changes in data obtained from the analysis.

This invention relates to a method for tracking responses to advertising campaigns.

### BACKGROUND OF THE INVENTION

Government, corporations, and organizations invest significant amounts of money and resources to deliver communications or when advertising their products and services. In most cases, they do not have an accurate method of measuring the performance of those initiatives and are forced to rely on intuition in making upcoming marketing decisions.

### SUMMARY OF THE INVENTION

It is one object of the invention to provide an arrangement which eliminates the guess work and provides factual evidence to assist organizations to make informed decisions about managing their overall on-going marketing budgets through statistical analysis of the actual response data.

According to one aspect of the invention there is provided a method for tracking responses to advertising campaigns comprising:

placing for a client advertisements in a plurality of different outlet media channels for accessing target recipients of the campaign;

monitoring at a monitoring location responses from recipients to the campaign;

applying an analysis to the responses received to attribute at least some of the responses to the different outlet media channels,

and displaying on a display screen for the client data obtained from the analysis.

Preferably the data when displayed is modified in real time to include real time changes.

Preferably different response addresses are provided for the different outlet media channels and wherein the addresses are all routed to the monitoring location and the analysis is dependent on the different addresses used.

Preferably the responses are effected by telephone and the different addresses comprise different phone numbers.

Preferably the phone calls to the different phone numbers are routed through the monitoring location and forwarded to the client.

Preferably the responses are effected by direct mail and the different addresses include a different address component.

Preferably the responses to the different outlet media channels are attributed to different locations geographically.

Preferably the responses to the different outlet media channels are attributed to different outlets in a single media channel.

Preferably the outlet media channel is a web site and applying the analysis is carried out by causing the recipient to download from the monitoring location a component of a page which allows the monitoring location to identify the recipient who has downloaded the page.

Preferably the responses are sent by email or web-form and there is provide a system by which the responses to the client are copied and sent to the monitoring location.

Preferably the analysis includes analysis of different response types so as to distinguish between two or more of the following: Inquiry, Application, Registration, and Request for More Information.

Preferably, in the event that different response addresses are not used on some or all responses, those responses are evaluated by a neural network to analyze response data and attribute each response to a specific media channel.

Preferably the neural network acts to determine a breakdown of the different media channels for a specific media channel using information obtained from distribution times of advertisement on the media channels and response times.

Preferably the neural network acts to determine a breakdown of the different media channels for a specific media channel using information obtained from geographic distribution of locations of advertisements on the media channels and response locations.

Preferably the neural network acts to determine a breakdown of the different media channels for a specific media channel using information obtained from shelf life.

According to a second aspect of the invention there is provided a method for tracking responses to advertising campaigns comprising:

placing for a client advertisements in a plurality of different outlet media channels for accessing target recipients of the campaign;

monitoring at a monitoring location responses from recipients to the campaign;

applying an analysis to the responses received to attribute at least some of the responses to the different outlet media channels;

and displaying on a display screen for the client data obtained from the analysis;

wherein, in respect of some media channels different response addresses are provided for the different outlet media channels;

wherein the addresses are all routed to the monitoring location and the analysis is dependent on the different addresses used;

and wherein, in the event that different response addresses are not used, all responses are evaluated by a neural network to analyze response data and attribute each response to a specific media channel.

The arrangement disclosed herein thus provides a process that gauges the effectiveness of Media Channels in motivating their audiences to action. By capturing response data and attributing it to specific Media Channels the display system for the client engine is able to display, in real time, the success of any mass media campaign.

The media channels which the arrangement is primarily concerned with are as follows:

Radio

Television

Newspaper

Websites

Magazine

Billboards

It will be appreciated that a recipient may reply with many different response types and that these can be determined and used as part of the analysis, as follows:

Inquiry

Application

Registration

Ballot

Request for More Information

It will be appreciated that a recipient may reply with many different response media depending on the request in the campaign data, and that these can be determined and used as part of the analysis, as follows:

Postal Mail

Web page download

Fax

Phone

Email

Web-form Submission

Web Site Visit

In Person Visit

One key point in the analysis method is that or response attribution. This can be carried out by a precise method in which each media channel is given unique response channels. Thus different response addresses are provided for the different outlet media channels and in most cases the addresses are all routed to the monitoring location and the analysis is dependent on the different addresses used.

Thus in respect of fax or phone responses, the responses are effected by telephone and the different addresses comprise different phone numbers. Thus the response phone calls to the different phone numbers given are routed through the monitoring location and forwarded to the client after the data is extracted and recorded concerning the attribution.

When the responses are effected by direct mail, the different addresses can include a different address component which allow the responses to be received by the monitoring location and the attribution extracted without the necessity to open the material.

In respect of Web page download where the outlet media channel is a web site, the analysis is carried out by causing the recipient to download from the monitoring location a component of a page which allows the monitoring location to identify the recipient who has downloaded the page and to extract the attribution data. The component of the web page can be invisible or irrelevant to the recipient so that they are not aware of the action taking place.

When the responses are sent by email there is provide a system by which the responses to the client are sent to the monitoring location, tracked, attributed to the media channel that generated the response and forwarded on to the client.

When the responses are sent by web-form, that is the entry of data onto a web page form supplied by a site there is provide a system by which the responses to the client are sent to the monitoring location, tracked, attributed to the media channel that generated the response and forwarded on to the client.

When the responses take the form of an in person visit there exists a mechanism to record the visit and attribute it to the media channel that generated the response.

In the event that it is not possible or desirable for the client to utilize different response addresses for a campaign, the applied method will be used to generate the data by attribution to specific media channels.

Thus all responses are evaluated by a neural network to analyze response data and attribute each response to a specific media channel.

Thus for example the neural network acts to determine a breakdown of the different media channels for a specific media channel using information obtained from distribution times of advertisement on the media channels and response times. By analyzing the date and time that a specific response occurred and considering the schedules of the each of the advertisements delivered the network assess the likelihood that the response was generated from a specific advertisement. For example, newspaper ads are distributed on specific publication dates.

Thus for example the neural network acts to determine a breakdown of the different media channels for a specific media channel using information obtained from geographic distribution of locations of advertisements on the media channels and response locations. For example newspaper ads appear in specific publications that have a defined geographic distribution.

Thus for example the neural network acts to determine a breakdown of the different media channels for a specific media channel using information obtained from shelf life. Each type of media channel has a specific shelf life. That is the length of time from the publication or distribution of the message that it can be expected to generate response.

Thus by analyzing the date and time that a specific response occurs and instructing the neural network to consider the geographic constraints, publication dates and times, and relative shelf life of each of the media channels that distributed message the network can attribute the response to the media channel that was most likely responsible for generating it. In this manner the applied method of response attribution can determine the effectiveness of each of the media channels.

In regard to the analysis and display of the data, the software receives the raw data on the attribution and provides real-time reporting of response data. As response occur they are recorded, attributed, and reported. The system provides a web-based dashboard that clients can log into and view the information graphically or in raw data tables. Custom graph types are created for each customer so they can view and analyze the data in the way that is most appropriate to them. For example, many clients have their own sales territories defined. These territories can be displayed on maps showing the aggregate responses for specific time periods as selected by the user.

The arrangement described herein can be used to monitor any media type in real-time, such as; newspaper, radio, television, magazine, billboards, yellow pages, web, email, and direct marketing. The response to each media channel is measured by geographic distribution and multiple demographic profiles as defined by the customer. For example if a specific customer is running a campaign targeting consumers in different age brackets, it is possible to measure the success being achieved in each of these brackets. In this manner response data can be analyzed in and across any demographic boundary as per the campaigns specific requirements. All media channels are measured and compared against each other to determine specific and overall return on investment.

The arrangement described herein can change the way corporations, advertising agencies, and government departments administer their marketing programs. The ability to monitor and evaluate the status of any initiative in real-time, creates the opportunity to make mid-stream campaign adjustments, thereby increasing overall effectiveness and efficiencies. Post campaign reports ensure transparency and accountability for marketing expenditures. These tools can become an essential part of their staff's ability to make better decision for future campaigns.

To get the most out of the marketing investment the technology identifies every lead generated and tracks the media-channel advertisement that produced it. Knowing in real-time, exactly which marketing investments are generating responses allows the client to make course corrections anytime throughout a campaign.

### BRIEF DESCRIPTION OF THE DRAWINGS

The following show a series of displays which can be used in presenting the information to the user:

FIG. 1 is a schematic illustration of the components used in the method according to the present invention.

FIG. 5 is a graph showing the breakdown by numbers of leads obtained from different sources.

FIG. 6 is a graph showing the breakdown based on a map of leads obtained from different locations.

FIG. 7 is a bar graph showing the breakdown based on the numbers of leads obtained from different cities.

FIG. 8 is a further display of a plurality of different graphs showing the breakdown based on the numbers of leads obtained from different media.

FIG. 9 is a further display of two bar graph showing firstly the number of applications by channel and the cost per application and secondly the number of responses by channel and the cost per response.

FIG. 10 is a graph showing the breakdown by percentages of responses based on age and culture.

FIG. 11 is a graph showing the channel cost vs the number of responses.

FIG. 12 is a graph showing the number of leads generated per month.

FIG. 13 is a graph showing the comparison of response rate, approval rate and delivery rate of a particular campaign relative to an average value.

FIG. 14 is a graph showing a comparison of advertising investment dollars and Leads generated in selected years.

### DETAILED DESCRIPTION

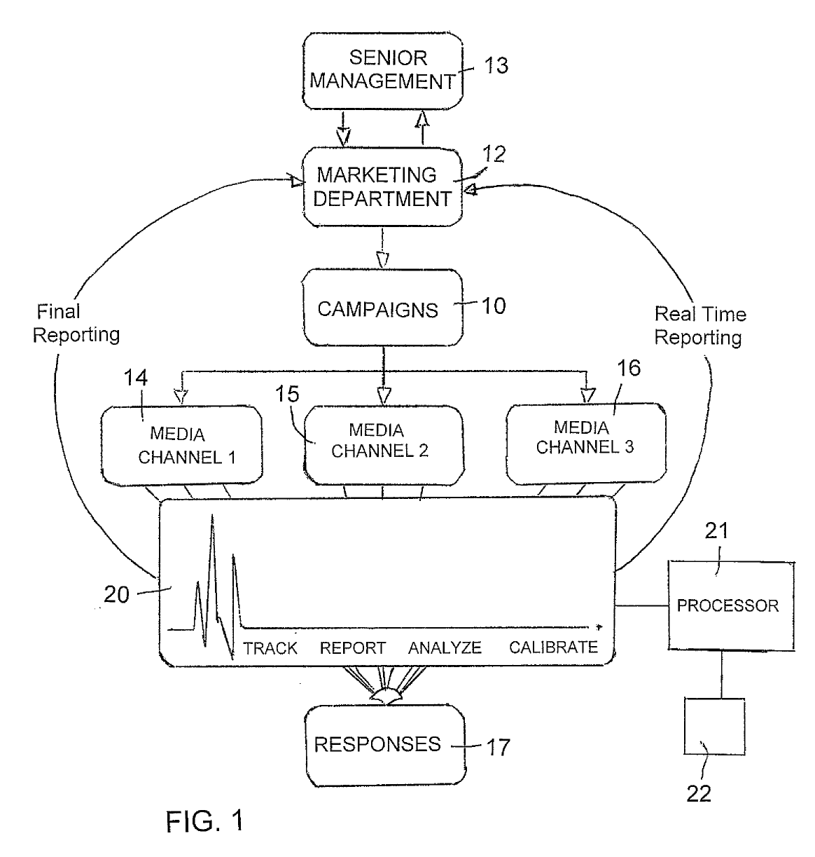

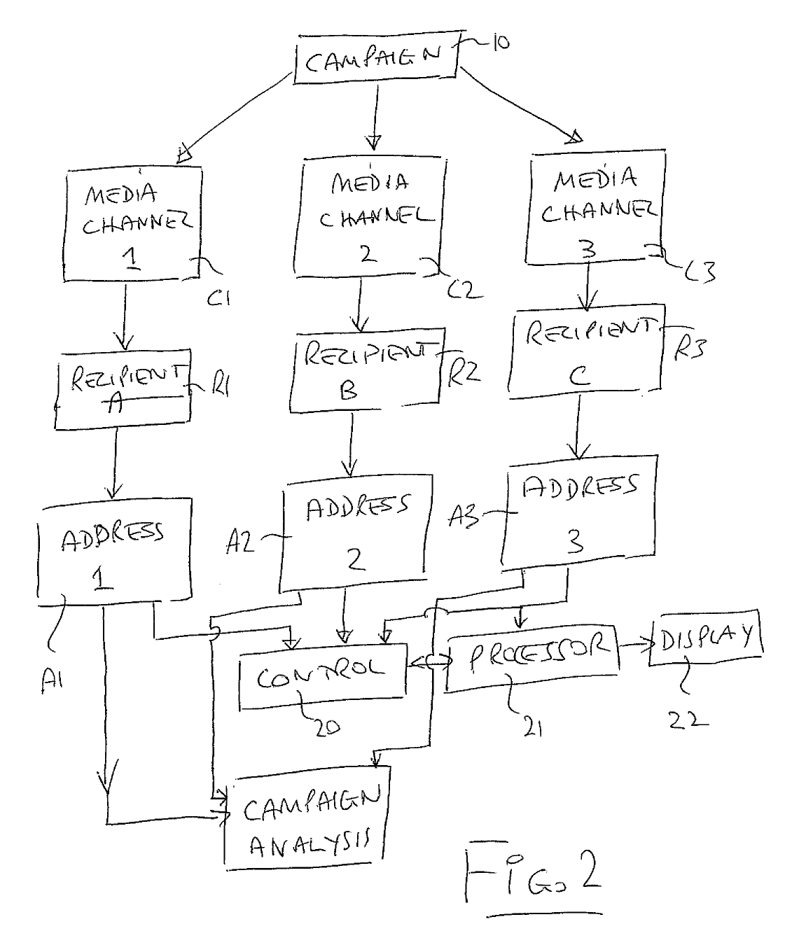

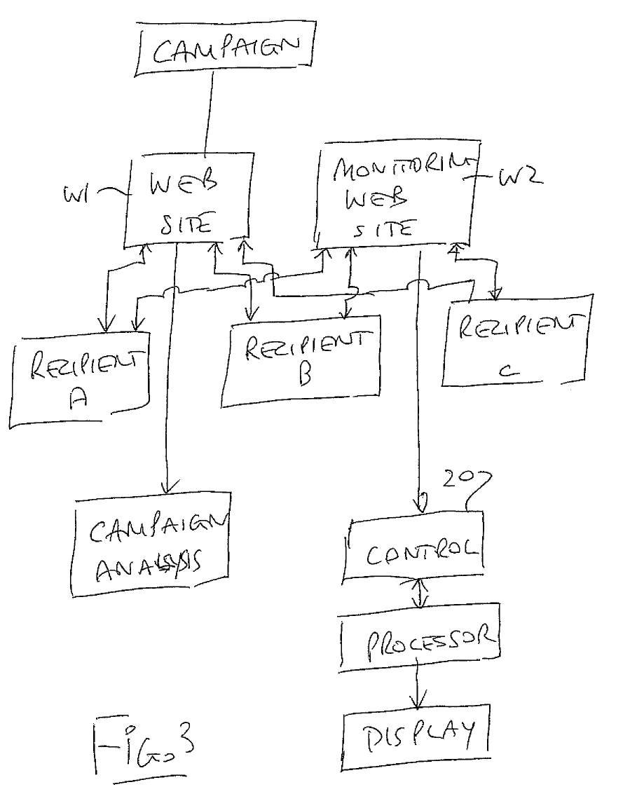

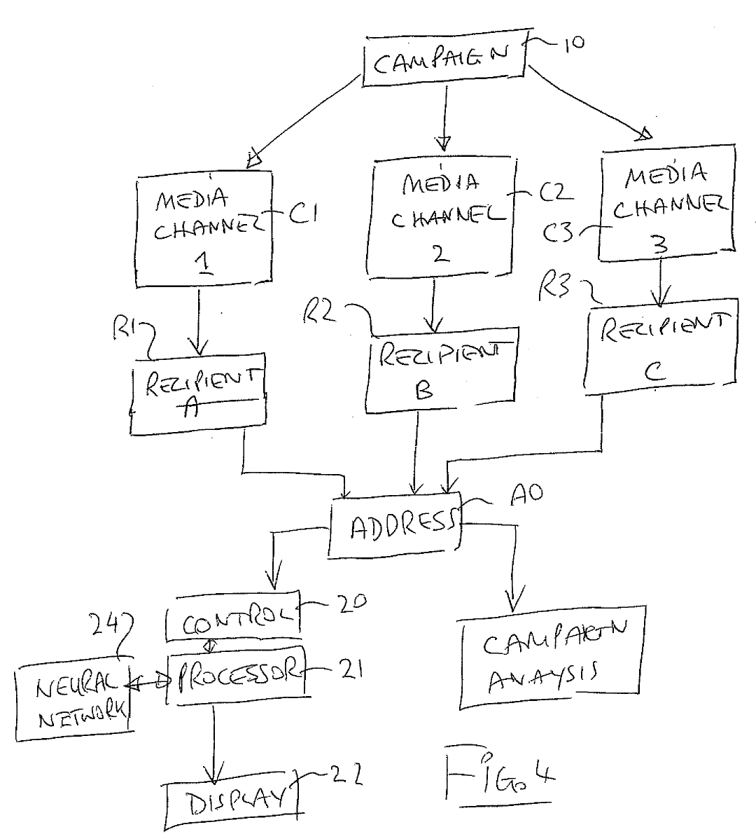

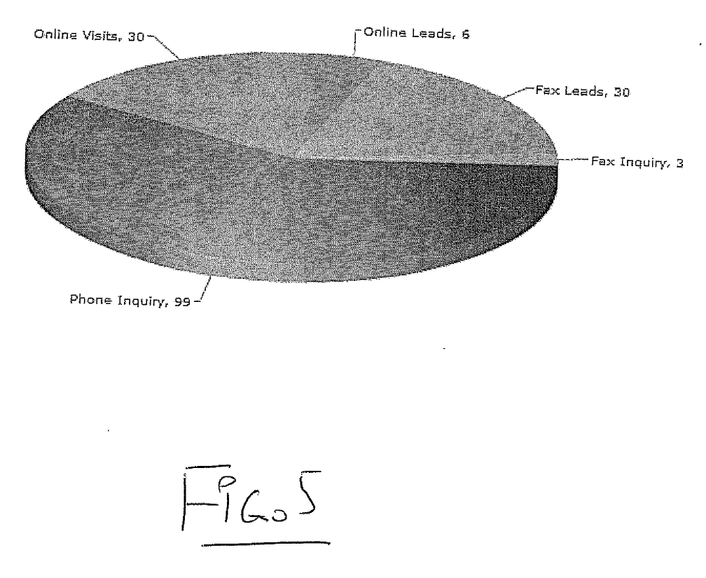

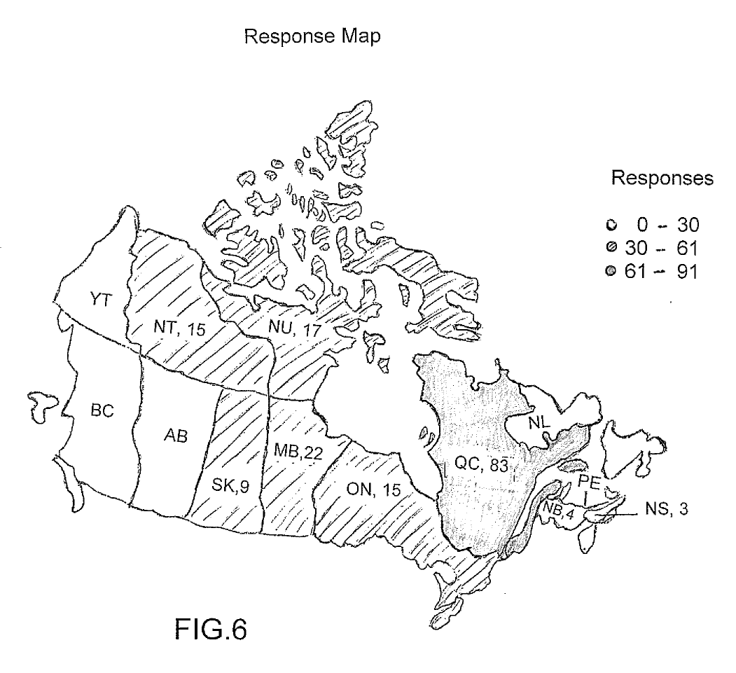

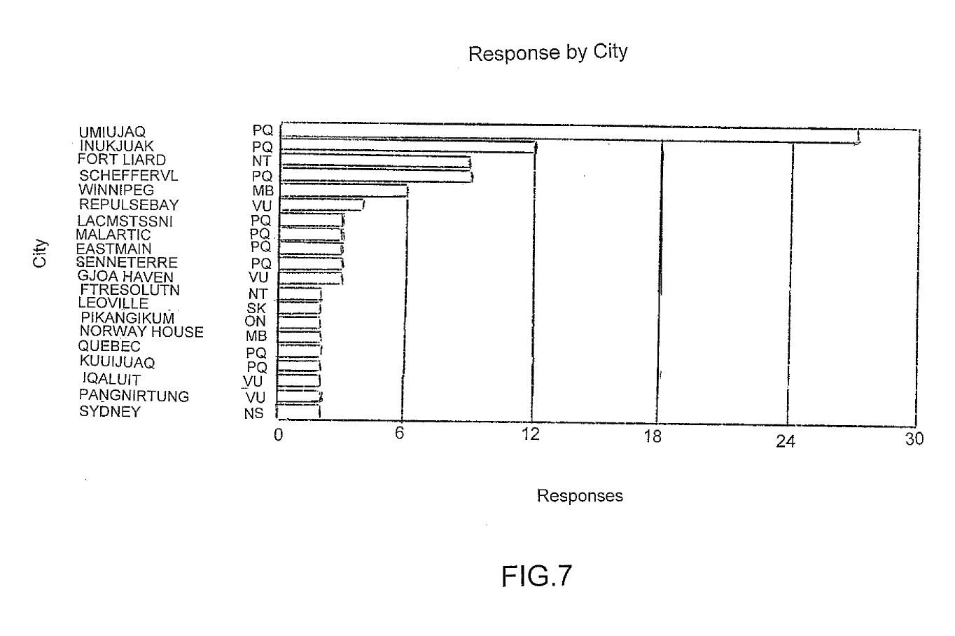

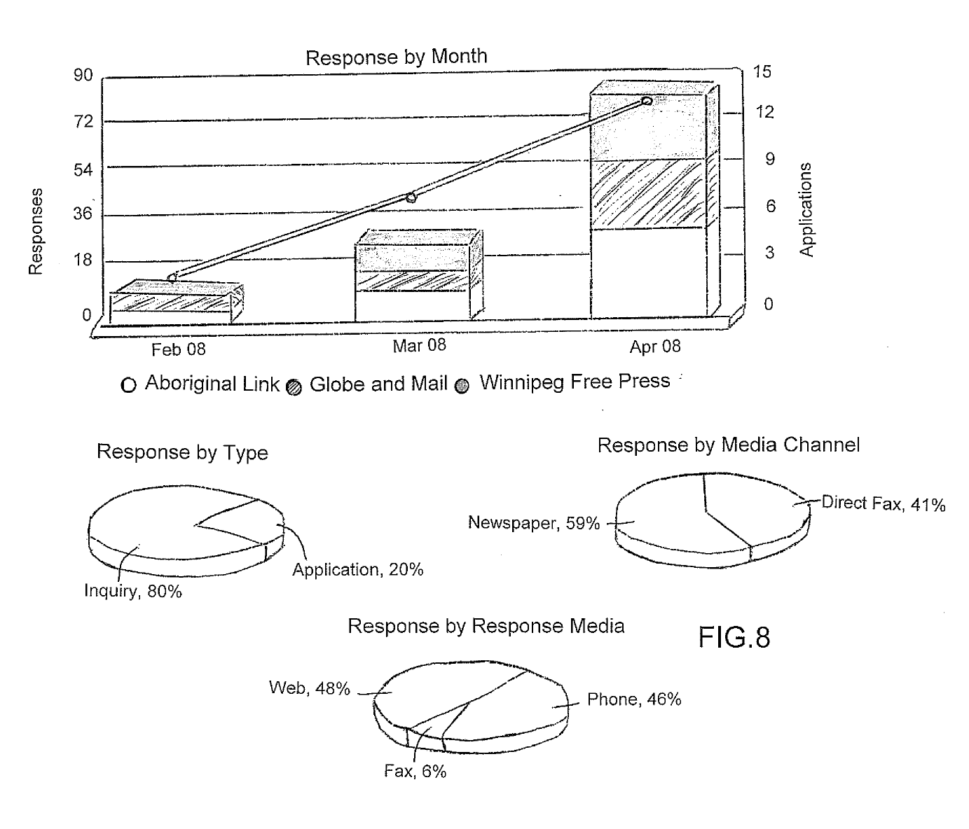

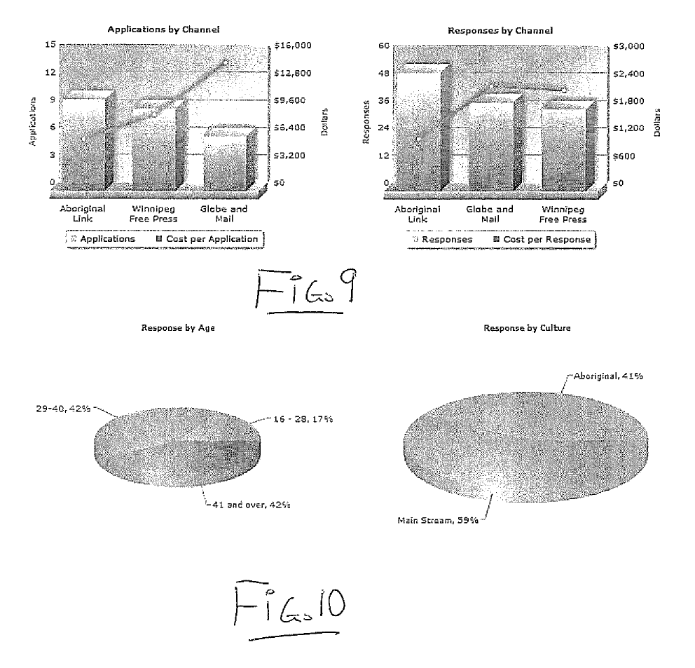

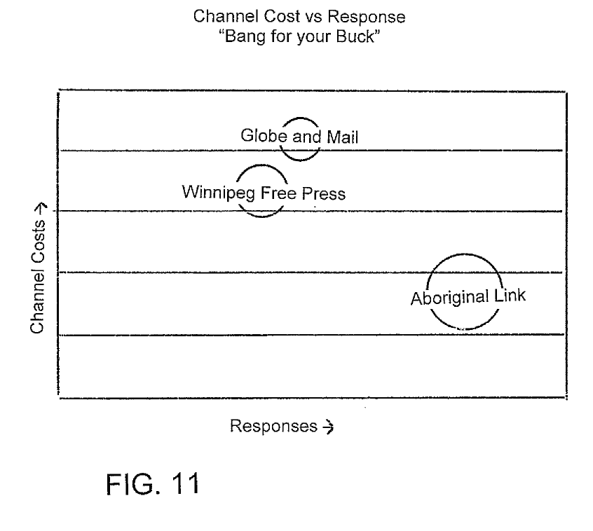

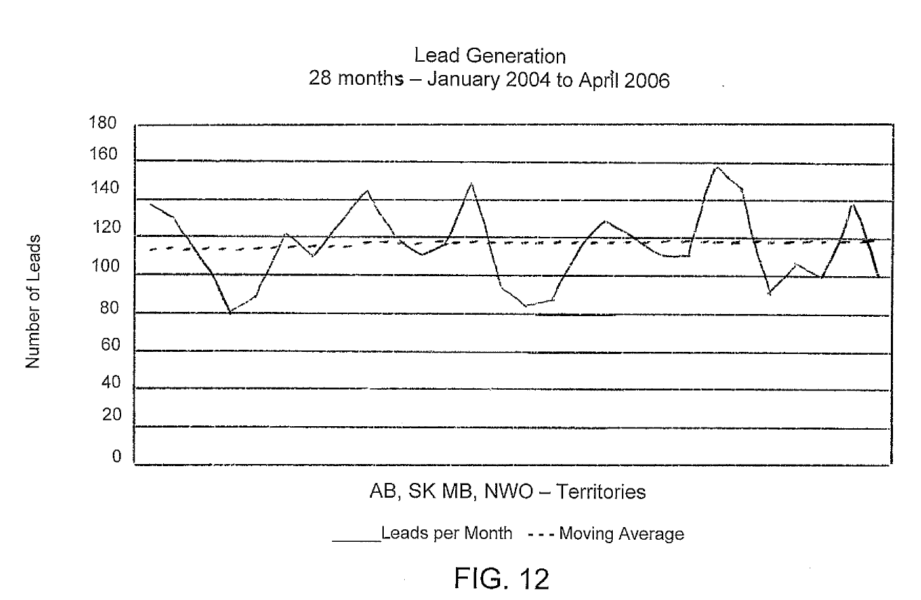

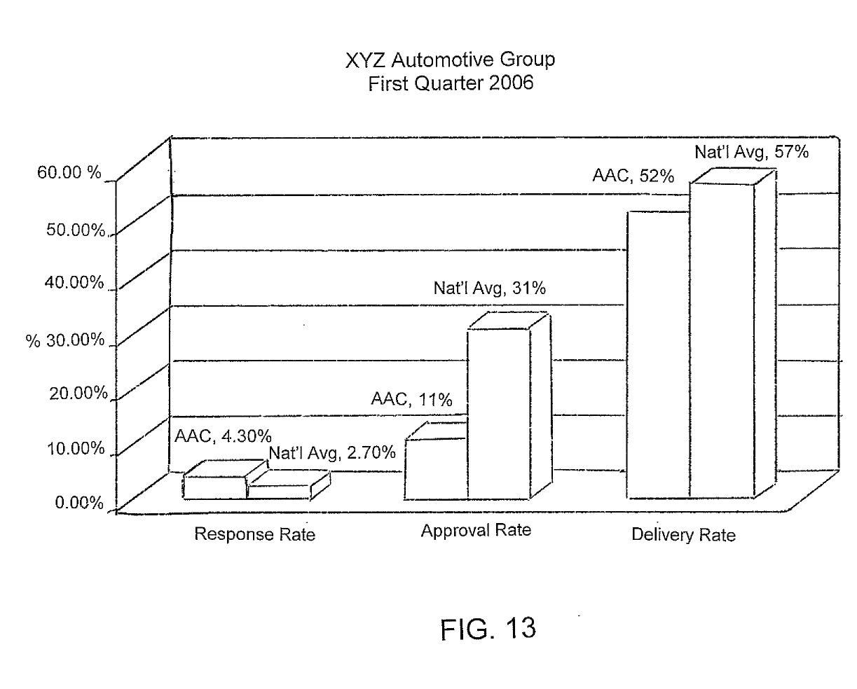

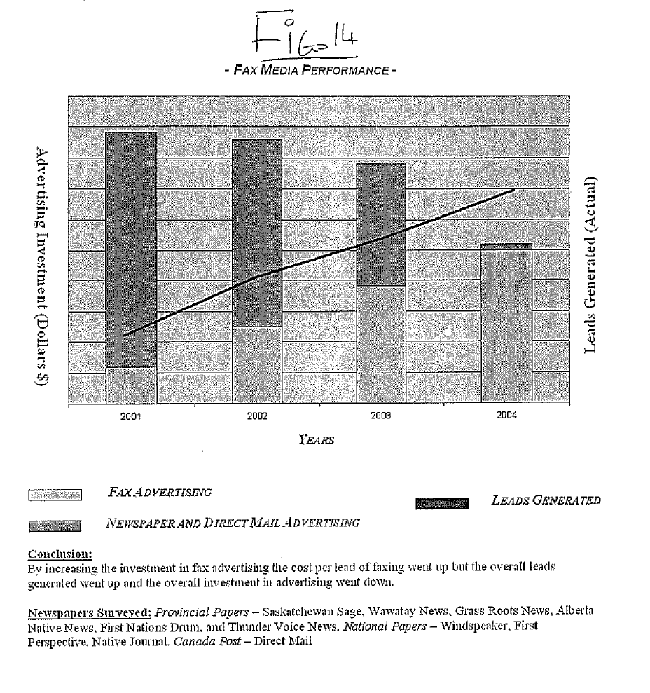

In FIGS. 1 to 4 is shown schematically the apparatus for carrying out the method for tracking responses to advertising campaigns described herein. Thus a marketing campaign is created as indicated at 12 by a marketing department 12 under control of a senior management team 13. In this campaign, client advertisements are placed in a plurality of different outlet media channels 14, 15, 16 for accessing target recipients of the campaign. The responses 17 from recipients to the campaign are monitored at a monitoring location 20 which includes a processing system for managing the responses and developing the various displays of FIG. 1 to 3 and 5 to 11. The location 20 includes a processor 21 and a display 22.

At the processor, the responses received are analyzed to attribute at least some of the responses to the different outlet media channels 14, 15 and 16. The processor acts to generate data obtained from the analysis as set out in FIGS. 1 to 3 and 4 to 11 and this data is displayed on a display screen for the client.

The processor 21 is arranged to modify the data when displayed in real time to include real time changes.

The processor 21 acts to carry out the analysis of the responses in a number of different ways.

Thus in one arrangement shown in FIG. 2 different response addresses A1, A2 and A3 are provided to receive responses from recipients R1, R2 and R3 for the different outlet media channels C1, C2 and C3 and wherein the addresses A1, A2 and A3 are all routed to the monitoring location at control 20 and the analysis carried out by processor 21 is dependent on the different addresses A1, A2 and A3 used.

Thus in another arrangement the responses are effected by telephone and the different addresses A1, A2 and A3 comprise different phone numbers. In this case, the phone calls to the different phone numbers are routed through the monitoring location and simply forwarded to the client after the data relating to the source is extracted.

Thus in another arrangement the responses are effected by direct mail and the different addresses A1, A2 and A3 include a different address component.

The processor 21 acts to carry out the analysis of the responses so that the responses to the different outlet media channels are attributed to different locations geographically.

The processor 21 can also be arranged to carry out the analysis of the responses so that the responses to the different outlet media channels are attributed to different outlets in a single media channel.

In another mode of operation shown in FIG. 3, the outlet media channel is a web site W1 and the analysis is carried out by causing the recipient to download from the monitoring location at web sire W2 a component of a page which allows the monitoring location to identify the recipient who has downloaded the page. This is then communicated to the control 20.

In another mode of operation, the responses are sent by email or web-form and there is provide a system by which the responses to the client are copied and sent to the monitoring location.

In another mode of operation, the analysis includes analysis of different response types so as to distinguish between two or more of the following: inquiry, application, registration, and request for more information.

In another mode of operation shown in FIG. 4, in the event that different response addresses are not used so that some or all responses from recipients R1, R2 and R3 are directed to a single address A0, all responses are evaluated by a neural network 24 to analyze response data and attribute each response to a specific media channel.

This can be done by the neural network acting to determine a breakdown of the different media channels for a specific media channel using information obtained from distribution times of advertisement on the media channels and response times.

This can be done by the neural network acting to determine a breakdown of the different media channels for a specific media channel using information obtained from geographic distribution of locations of advertisements on the media channels and response locations.

This can be done by the neural network acting to determine a breakdown of the different media channels for a specific media channel using information obtained from shelf life.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for tracking responses to advertising campaigns comprising:
placing for a client advertisements in a plurality of different outlet media channels for accessing target recipients of the campaign;
monitoring at a monitoring location responses from recipients to the campaign;
applying an analysis to the responses received to attribute at least some of the responses to the different outlet media channels;
and displaying on a display screen for the client data obtained from the analysis.

2. The method according to claim 1 wherein the data when displayed is modified in real time to include real time changes.

3. The method according to claim 1 wherein different response addresses are provided for the different outlet media channels and wherein the addresses are all routed to the monitoring location and the analysis is dependent on the different addresses used.

4. The method according to claim 1 wherein the responses are effected by telephone and the different addresses comprise different phone numbers.

5. The method according to claim 1 wherein the phone calls to the different phone numbers are routed through the monitoring location and forwarded to the client.

6. The method according to claim 1 wherein the responses are effected by direct mail and the different addresses include a different address component.

7. The method according to claim 1 wherein the responses to the different outlet media channels are attributed to different locations geographically.

8. The method according to claim 1 wherein the responses to the different outlet media channels are attributed to different outlets in a single media channel.

9. The method according to claim 1 wherein the outlet media channel is a web site and applying the analysis is carried out by causing the recipient to download from the monitoring location a component of a page which allows the monitoring location to identify the recipient who has downloaded the page.

10. The method according to claim 1 wherein the responses are sent by email or web-form and there is provide a system by which the responses to the client are copied and sent to the monitoring location.

11. The method according to claim 1 wherein the analysis includes analysis of different response types so as to distinguish between two or more of the following: inquiry, application, registration, and request for more information.

12. The method according to claim 1 wherein, in the event that different response addresses are not used, all responses are evaluated by a neural network to analyze response data and attribute each response to a specific media channel.

13. The method according to claim 12 wherein the neural network acts to determine a breakdown of the different media channels for a specific media channel using information obtained from distribution times of advertisement on the media channels and response times.

14. The method according to claim 12 wherein the neural network acts to determine a breakdown of the different media channels for a specific media channel using information obtained from geographic distribution of locations of advertisements on the media channels and response locations.

15. The method according to claim 12 wherein the neural network acts to determine a breakdown of the different media channels for a specific media channel using information obtained from shelf life.

16. A method for tracking responses to advertising campaigns comprising:
placing for a client advertisements in a plurality of different outlet media channels for accessing target recipients of the campaign;
monitoring at a monitoring location responses from recipients to the campaign;
applying an analysis to the responses received to attribute at least some of the responses to the different outlet media channels;
and displaying in real time on a display screen for the client real time changes in data obtained from the analysis;
wherein, in respect of some media channels different response addresses are provided for the different outlet media channels;
wherein the addresses are all routed to the monitoring location and the analysis is dependent on the different addresses used;
and wherein, in the event that different response addresses are not used, all responses are evaluated by a neural network to analyze response data and attribute each response to a specific media channel.

17. The method according to claim 16 wherein the neural network acts to determine a breakdown of the different media channels for a specific media channel using information obtained from distribution times of advertisement on the media channels and response times.

18. The method according to claim 16 wherein the neural network acts to determine a breakdown of the different media channels for a specific media channel using information obtained from geographic distribution of locations of advertisements on the media channels and response locations.

19. The method according to claim 16 wherein the neural network acts to determine a breakdown of the different media channels for a specific media channel using information obtained from shelf life.
